(19) United States
(12) Patent Application Publication
(10) Pub. No.: US 2016/0070775 A1
(43) Pub. Date: Mar. 10, 2016

(54) AUTOMATED CREATION OF AUDIENCE SEGMENTS THROUGH AFFINITIES WITH DIVERSE TOPICS

(71) Applicant: Temnos, Inc., San Jose, CA (US)

(72) Inventor: Timothy A. Musgrove, Morgan Hill, CA (US)

(21) Appl. No.: 14/662,155

(22) Filed: Mar. 18, 2015

Related U.S. Application Data
(60) Provisional application No. 61/955,752, filed on Mar. 19, 2014.

(51) Int. Cl. G06F 17/30; G06Q 30/02

(52) U.S. Cl. CPC G06F 17/30598; G06F 17/30011; G06Q 30/0255

(57) ABSTRACT

A method, apparatus and computer readable media for automated creation of audience segments through affinities with diverse topics. A collection of documents having assigned topics is received, wherein, for any given topic, only a minority of the collection has that topic. A first set of documents in the collection that are in a target category is determined. A second set of all documents in the collection having a threshold number of differentially frequent occurring topics that are differentially frequent in the first set, but where such documents are categorized expressly as not belonging in the target category is determined. Topics occurring frequently in the first set but seldom in the second set are designated as anchors. Topics occurring frequently in both the first set and the second set are designated as tethers. For each tether, the anchor(s) with which it has a strong co-occurrence tendency are assigned as anchor(s) therefore.

### CLAIM TO PRIORITY

This application claims priority to U.S. Provisional Application No. 61/955,752, filed Mar. 19, 2014 (now pending), the disclosure of which are hereby incorporated by reference in their entirety.

### BACKGROUND

This concerns a method for automatically creating and updating diverse topics sets representing audience affinities, in a way that enables targeting of audience segments via content. The primary use case is for targeted advertising, though it could be used for content discovery and recommendation or other purposes.

Advertising in any medium is usually targeted toward a particular audience or audience segment. Generally we may speak of direct and indirect audience targeting. Direct audience targeting occurs when an advertisers has data directly from whoever is placing (or enabling the placement of) the ads, about the specific users who are consuming the surrounding media into which the ads are to be placed. But in many instances, no such data is available, and advertisers must turn to indirect means of audience targeting.

One type of indirect audience targeting is when someone places billboard ad along a specific stretch of freeway for the purpose of reaching a specific type of audience. For example on the 101 freeway connecting San Francisco and Silicon Valley, there are a high number of billboards advertising enterprise infrastructure products that only executives of medium-to-large technology companies would be in a position to recommend or approve for purchase. Although there is no audience data directly available for the freeway, because it is a main commuter thoroughfare in a region densely populated by such companies, the advertisers are indirectly targeting this audience by means of the billboards.

Another way to indirectly target an audience would be by an it's affinity with particular topics of content. One example of this happens sometimes when a brand new radio or television program first comes on, that has had no previous audience analysis data, because it is a brand new show. If the show is related to, say, cooking, then cooking enthusiasts can be assumed as a good target audience or advertisers, on the basis of that audience having a presumed affinity with the content. After the show has been on for several episodes, it often may be surprising which audience segments actually watch it the most. If the host is entertaining and comical, many non-cooking-enthusiasts might watch. If the host is young and attractive, it might draw a young audience. If the host travels to exotic places to discover unusual recipes, the show might attract a travel-minded audience just as much as food-oriented audience. And so on. The point is that in the beginning, the show's producers know none of this, and the team selling ads for the show cannot be certain about the type of audience it will draw. So in the beginning they will pitch advertisers they know are likely to be aiming at audiences having an affinity with the content of the show, i.e. home cooks and “foodies”.

The contrast between direct and indirect audience targeting is made more complicated on the World Wide Web, where privacy advocates and, some would say, a sense of common decency, are often fighting against the methods preferred by advertisers for direct capture of audience. Browser cookies, user profiles, universal logins shared across pluralities of websites, and other means of direct user tracking, enable advertisers to directly address a pool users having the characteristics of their target audience. But at the same time, browser makers, handset carriers, and local and national governments are all making moves to block third-party cookies, limit sharing of user profiles between companies, and so on. Thus there exists a need for indirect audience targeting on the World Wide Web. The present invention satisfies this need by the creation of audience affinities with taxonomically disparate topic sets in a way that critically enables indirect audience targeting, and is scalable.

### DETAILED DESCRIPTION

By “taxonomically disparate” topic sets, we mean that in a hierarchical arrangement of the topics (or characteristics thereof) addressed, wherein strict parent-child relationships obtain (such that every child node is a sub-type that belongs under its parent node), then the topics or characteristics with which an audience has strong affinities, do not usually fall under a particular branch of taxonomy, but instead, are to be found in many diverse points all around the hierarchy of topics. An example of a taxonomically disparate collection of topics would be: all the topics of concern to home-brewers. These would include not just things like imported hops and tips of how to use stackable brewing hoppers, but also things such as horticultural tips on growing your own hops, tax questions about deducting home-based brewing expenses as a hobby or small business expense, local laws limiting the production of alcohol in a residential location, tips on how to get a small business loan to finance a home-brewery scaling up to a professional level, etc. Note that these topics, in a general taxonomy, would fall some under the category of Law, some under Taxes, some under Finance, some under Agriculture, etc. Capturing these and several hundred more topics, we could have a complete “topic map” of the content with which home-brewers have affinities, i.e. are interested in to a much higher-degree than the general population. We will name the entire topic map itself a “megatopic”, though it could be called something else.

Naturally, to create such megatopics manually for hundreds or more audience segments which advertisers desire to target, would be a formidable task, and one never really finished, since new topics of concern arise all the time in every audience segment. Thurs there is a need to automate or accelerate the process.

In so doing, this invention presumes the existence of a structured or layered clustering method, which can be invoked from a third party or fashioned especially for this invention. A layered clustering method is one that establishes more than one vector of features, such that the presumed relevance to the target topic or category, differs both qualitatively and quantitatively, between the vectors. Differing quantitatively means that features in one vector are weighted heavier or are worth a higher score, than features in the other vector, notwithstanding that individual features might differ in score or weight also within the same vector. Differing qualitatively means that some n number of features in the heavier weighted or higher scoring vector, are necessary and required, in order for there to be a classification into the target topic or category, whereas the lower weighted vector used for further refinement of scoring classification, embellishment of features that represent the nature or justification of the classification, and/or measuring depth of topic treatment of the item being classified, with respect to the category of classification—but without it being necessary or required that a feature in this vector be discovered, in order to enable classification. In other words, at least one vector of features (which may include disjunctive features) are required features, whereas at least one other vector of features are only “nice-to-have” features. Any clustering or classifying mechanism which has this distinction, is herein referred to as “structured clustering.” In the preferred embodiment of the present invention, we invoke the method of anchor-tethering from a third-party structured clustering engine. This method establishes “anchor” features and “tethered” features, where a number of vectors of tethered features exist where in each vector is assigned one (or a small number of) anchor feature(s) from within a single anchor feature vector. Via this mechanism, in order for a candidate item to be assigned any tethered feature, it must first be discovered to have the associated anchor feature(s); if it does, then it is assigned not only that anchor feature, but also any features tethered to that anchor which are indicated in the candidate item's feature extraction output.

The most straightforward way to fashion the anchored and tethered features, is to editorially specify them with the work of human subject matter experts (SME's). An alternative it to employ a clustering algorithm which discovers them automatically, by creating clusters according to any method extant in the art, while also (or afterwards) distinguishing anchors and tethers as defined above.

A unique challenge is created however when established topics, and/or established document sets, have been editorially chosen as exemplars for an audience segment, and we wish to then create anchors and tethers automatically from such example sets. In such a case there is a need to determine viable anchors and tethers in an automated fashion. The present invention accomplishes that in the following manner:

The end goal is to create anchor/tether topic sets from manually categorized training data. Procedure is as follows:
Start with a collection of documents already assigned topics (represented as categories, topics, sub-topics, parent-topics, meta-topics, keywords, phrases, or tags, or functionally similar elements), such that, for any given topic, only a minority of the corpus (preferably less than 10%) has that topic.
Collect from the corpus all documents manually categorized into a target category.
Collect separately all documents sharing above a threshold number of differentially frequent occurring topics with those that are differentially frequent in the above collection from step 2, but where such documents are manually categorized expressly as *not* belonging in the target category. “Differentially frequent” means occurring relatively more frequently than in the entire corpus.
Designate topics occurring frequently in the first collection but seldom in the second collection, as the anchors.
Designate topics occurring frequently in both collections as the tethers.
For each tether, the anchor(s) with which it has a sufficiently strong co-occurrence tendency, are its assigned anchor(s).

Another embodiment would separate anchors and tethers by designating topics that more frequently occur in user queries, in user comments, in article titles, in article sub-titles, and in article call-outs, as the anchors, and topics that occur instead more frequently in the article body but not in the titles, queries, comments, etc. as the tethers. In this case, each of the tethered topics would be tethered specifically to those among the anchors with which it most commonly co-occurred.

And any method which determines or construes some topics to be essential or disjunctively essential, while others are determined or construed to be relevant-but-not-essential, would suffice for this element of the present invention.

In an optional refinement of the present method, in any of its embodiments, we can allow creation of related-but-contrary or “contrastive” megatopic relations. These need not be strictly exclusive, but rather weigh against each other to a variable degree. An example would be small business and large business. Obviously these two are closely related, and thus easily conflated; but if a document scores moderately in one and very strong in the other, then we would disqualify it for the one in which it scored modestly. This is to avoid false positives. Other examples would be screenwriting vs. playwriting, car racing vs. motorcycle racing, etc. These examples look a lot like sibling categories in a taxonomy, of course, and some of them in fact be derived by walking a subject matter taxonomy, even automatically.

However, it is important to note that there are other examples where contrastive megatopics are not at all likely to be sibling categories in a taxonomy. Take for example “tax software” and “tax preparation services”. Even though both concern taxes, the former is likely to be under a Software branch of a hierarchy tree while the latter is under a Business Services branch. Yet their member topics would overlap significantly, either by extension or by intension or both. Thus they would recommend themselves as contrastive megatopics, even if they were not sibling categories in the associated taxonomy for the corpus in question.

This hearkens back to our taxonomical disparity discussion above, only this time we are interested to separate content that could readily be conflated. One way of automatically doing so, is noticing the particular combination of scores mentioned above: where a document scores high enough in both that it would pass our set threshold of significance in either case, and thus seems to belong in both of them. But when there is a very marked difference in scores between the two, despite them both being above the threshold of significance, we would enforce a “winner take all” approach—but this being only for contrary megatopics, where it is held that one should trump the other, as it were.

What about when there is not a large score difference between contrastive megatopics? In this case we can pronounce the case an ambiguous one: as if to say, this document has affinities with a business audience and we are unsure whether it is meant more for large or small business, or is attempting to appeal to both. Alternatively we can pronounce that the document is indeed aiming at both: and this is just a matter of preference upon whomever is administering this system and wishes to handle such cases. If looking for the most applicable inventory possible for an ad, one will use the latter approach. If looking to exclude anything that has even a mild chance of not being the exactly correct audience, then one will use the former approach. Our apparatus enables both.

Thus being given just a sample of documents representing the interests of an audience segment, we can completely create “audience affinity” segments from the “long tail” of vast Internet content, finding just those pages that should “resonate” with the intended audience segment. And the system is very transparent, in that it operates by a megatopic, wherein any person can readily see the plurality (perhaps dozens or hundreds) of member topics. Thus it is easily presentable, explainable, and editorially correctable, while still being created by an automated process.

The invention can be implemented as a method, a computer apparatus, or as instructions on computer readable media.

What is claimed is:

1. A method comprising:
receiving a collection of documents having assigned topics, wherein, for any given topic, only a minority of the collection has that topic;
determining a first set of all documents in the collection that are manually categorized into a target category;
determining a second set of all documents in the collection having at least a threshold number of differentially frequent occurring topics with those that are differentially frequent in the first set, but where such documents are manually categorized expressly as not belonging in the target category;.
designating topics occurring frequently in the first set but seldom in the second set, as anchors.
designating topics occurring frequently in both the first set and the second set as tethers; and
for each tether, assigning the anchor(s) with which it has a sufficiently strong co-occurrence tendency as anchor(s) therefore.
